(19) United States
(12) Patent Application Publication
(10) Pub. No.: US 2003/0161084 A1
(43) Pub. Date: Aug. 28, 2003

(54) Protection systems for power networks

(76) Inventors: Stephen Charles Potts, Staffordshire (GB); Neil Leslie Robinson, Staffordshire (GB)

Correspondence Address: Alan Israel, Kirschstein Ottinger Israel & Schiffmiller, 489 Fifth Avenue, New York, NY, 10017, US

(21) Appl. No.: 10/239,943

(22) PCT Filed: Jan. 29, 2002
(86) PCT No.: PCT/GB02/00373

(30) Foreign Application Priority Data
Jan. 31, 2001 (GB) 0102409.0

(51) Int. Cl. H02H 3/00

(52) U.S. Cl. 361/62

(57) ABSTRACT

A protection system for an electrical power network uses a method of determining the times of capture of current signals obtained by protection devices (3A, 3B) at first and second spaced points along a power line. Measurements are captured at the first device (3A) and sent to the second device (3B), which captures a second measurement and sends a reply to the first device. The timing of both measurements is synchronised using a GPS signal, and the total propagation time tp1+tp2) of the outward and return signals (S1, S2) is stored in a memory. In the event that the GPS signal is lost, the stored propagation time is used to calculate the actual time of the second measurement relative to the first measurement.

### FIELD OF THE INVENTION

This invention relates to protection systems for electrical power networks, and in particular to improvements in fault current monitoring in such systems.

### BACKGROUND OF THE INVENTION

In order to protect high power distribution networks from faults such as short circuits between phases it is known to divide the network into sections and to provide a protection device at each end of a section. Each protection device includes a current sensor, a data processor and an output switch to control the circuit breaker. The current sensors monitor the current flowing through a respective circuit breaker.

The protection devices at each end of a section are connected by a communication network and signals representing the current measurements are transmitted across the communication network from one device to the other. Each device then compares its own measured current with the current measured at the other end of the section to identify faults in the power line. If a fault is detected the isolating circuit breaker may be activated to break the flow of current to that section and isolate the fault. Because the current in the line is continuously varying it is important that only current measurements made at identical times (or measurements which are phase-aligned to simulate capture at identical times) are compared.

Although many different types of communication network topology have been used in the past, Synchronous Digital Hierarchy (SDH) is now one of the favoured communication network transmission schemes. A typical SDH scheme comprises a series of interlinking rings or loops. FIG. 1 of the accompanying drawings shows an SDH ring 1 provided with six nodes A-F.

Each such ring in the network comprises a continuous signal transmission path for the transmission of measurements between protection devices 3A, 3B at opposite ends of a section P of the power line 2.

The provision of a continuous loop permits transmission of signals between the two protection devices 3A, 3B served by the loop along either of two alternative transmit and return paths A-B/B-A or A-F-E-D-C-B/B-C-D-E-F-A. This provides for a degree of redundancy needed to accommodate faults in the communication network.

Normally, the shortest path which links the two nodes is used. This path is commonly referred to as the “worker” path. However, if there is a fault in this path, signals can flow between the two nodes by the longer path around the rest of the loop. This is commonly referred to as the “stand-by” path. Selection of the worker or standby path is achieved by providing routing switches at each node on the loop. As shown in FIG. 1, it is usual for two way communication to be provided between the nodes on the loop and in this case communication in each direction may be independently switched between the worker and the standby paths.

The current flowing in the power line will be typically sinusoidal and can be represented by a rotating current vector. In order to detect a fault, the processor associated with a protection device must only compare current values which correspond to the same moment in time. This either requires that the sensors at each end of a section of power line measure currents at exactly the same time or that the signals are phase aligned before comparing them. In both cases, therefore, a knowledge of the time at which the measurements are made is required.

Because the protection devices are located at different points along a power network—often many kilometres apart—they cannot be driven by a common oscillator to give each of them the same reference clock frequency. As such, they are driven by separate oscillators and so the measurements will not be synchronised unless special arrangements are made.

In one proposed solution to achieve synchronisation, the current measurements are transmitted across the communication network in pairs using a technique known as Numerical Current Differential (NCD) or “Ping-Pong” technique. A time-line diagram illustrating the timing of measurements under such a scheme is provided in FIG. 3 of the accompanying drawings. More complete details of one version of this known arrangement can be found in patent number GB 2 173 658 B, to which the reader is referred.

In the NCD technique, a first protection device A at one end of a section of power line takes measurements of the current at that point at times tA1, tA2, etc. and a second protection device B takes measurements of the current at the other end of the section of power line at times tB1, tB2, etc. The first measurement taken by device A is transmitted (after a fixed time delay ta) across the communication network to the protection device B. The transmission is in the form of a digital signal S1 which itself takes a certain finite time tt between start and end of transmission to be transmitted from device A. The first measurement taken by device A is accompanied by a time tag (i.e., a byte of data in the signal) representative of the time tA1 at which the first measurement was made. The device B finishes receiving this signal at a time tp1+ta after the measurement was made, where tp1 is the outward propagation time and ta is the delay between taking the measurement at time tA1 and sending the signal.

The second device B, after receiving the outward transmitted signal S1 at its own time tB* and waiting for a period tc, takes a second current measurement at its end of the power line section at a time tB3. (Note that as shown the sampling instants at the two ends will not in general be coincidental or in a fixed relationship due to slight drifts in sampling frequencies between the clocks in each device.) The second device then transmits a return signal S2 back to the first end. This signal contains the time tag tA1, the second current measurement, a second time tag tB3 representing the time of measurement of the second current measurement, and a delay time signal tc+td representing the total delay time between receiving the outward signal S1 and transmitting the return signal S2.

The return signal S2 is received at the first end by the first device A at a time tA* as measured by its own clock. The propagation time in each direction is assumed to be equal and so the return signal propagation time tp2 can then be calculated according to:

$$\begin{matrix}Return propagation time tp2 = Outward propagation time tp1 \\ = \frac{1}{2} ( {tA}^{*} - tA1 - ta - tc - td )\end{matrix}$$

From a knowledge of the return propagation time tp2, protection device A can calculate the sampling time tB3 of the second signal in terms of its own clock time as:

tB3=tA*−tp2−td

Once device A knows this, the current measurements by devices A and B can easily be compared by appropriate phase shifting of the current vectors.

While this technique has proven effective under many operating conditions, it is vulnerable to failure in a ring type topology because, as already mentioned, it is possible for the outward and return signals to have different propagation times.

In one proposed solution to this problem, the current sensors provided at each end of the power line section may be driven by oscillators which are synchronised to a common time frame derived from Global Positioning System (GPS) timing information. This ensures that all samples are taken at the same times. The measured values are then transmitted across the loop—either along the worker or along the standby paths—together with a time tag containing the GPS derived time of measurement.

The use of such a GPS signal has the benefit that the actual time of measurement of the currents is precisely controlled. The delay time for transmitting the information around the loop is irrelevant, because the time tags at each end have a common time frame. Therefore, it does not matter whether the signal is transmitted along the worker path or the standby path.

A problem with this approach is that-the synchronisation is completely lost in the event that the GPS signal is unavailable. At present, the GPS system is controlled by the United States government and as such there have been extended periods over which the signal has been unavailable.

### SUMMARY OF THE INVENTION

In brief, the invention provides a protection system for an electrical power network comprising a plurality of protection devices arranged in a synchronous digital hierarch, and having synchronising means using a common timing signal obtained from global positioning satellites, the protection devices being adapted to communicate with each other by means of the Numerical Current Differential (so-called “Ping-Pong”) technique. An important aspect of the invention concerns a method of determining the time of capture of current measurements obtained by first and second protection devices at first and second spaced apart points along a power line, a first current measurement being captured at the first device, which sends an outward signal including the first current measurement to the second device, a second current measurement being captured at the second device, which sends a return signal including both current measurements to the first device, the timing of both measurements being synchronised using a GPS signal, the total propagation time of the outward and return signals being calculated and stored in a memory, wherein if the GPS signal is lost, the stored total propagation time is used to calculate the actual time of measurement of the second signal relative to the first signal.

In the preferred embodiment, the protection devices are part of a communication network of the synchronous digital hierarchy type, and if the GPS signal is lost, the stored total propagation time is compared with total propagation times acquired during loss of the GPS signal to determine if the signal transmission path around the network has changed. If the transmission path changes, the method includes issuing a fault signal to alert observers that the operation of the protection devices is no longer reliable.

In more detail, the invention provides a method of determining the time of capture of current measurements obtained by first and second protection devices provided respectively at first and second spaced points along a power line, the method comprising:

(a) obtaining a first measurement of the current at the first point,

(b) generating a first time tag indicative of a time at which the first measurement was made;

(c) transmitting an outward signal from the first protection device to the second protection device, the signal including at least the first time tag;

(d) obtaining a second measurement of the current at the second point,

(e) generating a second time tag indicative of a time at which the second measurement was made; and

(f) transmitting a return signal from the second protection device to the first protection device, the return signal including at least the first and second time tags and data representing the second measured current; wherein:

(A) during a first mode of operation the method includes the steps of;

(i) generating each of the time tags to represent a time of measurement relative to a common time clock derived from a remote clock signal,

(ii) deriving from the information contained in the return signal a total propagation time for the outward signal and the return signal and

the outward signal propagation time and/or the return signal propagation time, and

(iii) storing the total propagation time and the outward propagation time and/or the return propagation time in a memory;

(B)during a subsequent second mode of operation in which the remote clock signal is unavailable, the method includes the further steps of;

(i) comparing a new total propagation time for an outward signal and a return signal with a value for total propagation time stored during the first mode of operation, and if the new and stored total propagation times are substantially identical,

(ii) deriving the time at which the second measurement was made by a calculation including

subtracting a value for return propagation time stored during the first mode of operation from the receive time of the return signal, or

adding a value for outward propagation time stored during the first mode of operation to the transmit time of the outward signal.

The remote clock signal may be obtained by providing a Global Positioning Satellite receiver for each of the first and the second protection devices and deriving the clock signal from the received GPS signal.

Thus, the invention uses the benefits of a GPS timing signal to provide absolute time values for the time tags to indicate exactly when the current measurements are made during normal operation. In the event of loss of the GPS signal the exact times at which the second measurements are made are determined by employing the stored values of the outward or return propagation times together with a measurement of the time of transmission of the outward signal or receipt of the return signal.

The outward and return signals may include the first current measurement.

The correct operation of the method when the GPS signal is unavailable relies upon the assumption that if the total propagation time has not changed, then the transmission path taken by the outward and return signals is probably unchanged.

If the total propagation time has altered it is safer to assume that the transmission path has altered and issue a fault signal. Thus, if the GPS signal is not available, the method preferably further comprises the step of issuing an error signal if the most recently calculated total propagation time and the value for total propagation time stored during the first mode of operation differ by an amount exceeding a predetermined value.

Where there is a significant time delay between capturing the first current measurement and transmitting the outward signal, and/or a significant time delay between receiving the outward signal and capturing the second current measurement, and/or between capturing the second current measurement and transmitting the return signal, the method of the invention should take account of these delays when determining the outward or return propagation times.

Hence, the outward signal may include first delay data representative of a time delay between obtaining the first measurement and transmitting the outward signal and the return signal may include the first delay data as well as second delay data representative of a time delay between receiving the outward signal and obtaining the second current measurement. The return signal may also include third delay data representative of a time delay between obtaining the second current measurement and transmitting the return signal. Thus, for example, the method of the invention can determine the propagation time of the outward signal by subtracting the relevant time delays from the difference between the time ofcapturing thefirst measurement and the second time tag value.

A current sample may be taken by each protection device on each clock pulse. The samples may be captured at 2.5 millisecond intervals. The GPS signal, when available, may be used to time-align the pulses of each of the clocks. Alternatively, the GPS signal may be used to phase-align the captured current values without altering the timing of the clock pulses. Time alignment of the signals is most convenient as it ensures that for each first current measurement at the first point on the power line section, a corresponding current measurement has been obtained at the same time at the second point. Comparison of the outward and return signals is then easy so that subsequent identification of faults in the section of power line can be accurately achieved.

It will of course be understood that the major components of the protection devices may be spaced from the actual points of capture of the first and second current measurements. For example, they may be provided in a housing supported a short distance from the current sensor and connected thereto by an appropriate electrical cable.

The current sensors may comprise current relays which directly measure the current. Alternatively, a proportion of the current in the power line may be passed through a resistor and the voltage across the resistor may be measured as an indirect indicator of current. Thus, the invention is not limited to directly measuring current but also covers indirect measurements of current.

The current measurements are preferably digitally sampled and may include data representing the phase of the measured current and the magnitude of the measured current.

In accordance with a further aspect, the invention provides a protection system (such as a synchronous digital hierarchy protection system) including at least first and second protection devices located respectively at spaced locations along a section of a power line and a communication network providing at least two different communication paths between the protection devices, each protection device including a clock signal generator synchronised to a time signal derived from a remote clock source which is common all the protection devices, a current sensor, a data processor, a transmitter for transmitting signals across the communication network, a receiver for receiving signals from the network and switch means for operating an associated circuit breaker in the power line, the data processors of the protection devices being configured to determine the relative time of capture of current measurements according to the method of the invention, wherein the data processor of each protection device is configured to operate the associated circuit breaker to isolate the section of line if the current measurements indicate the presence of a fault oil the line.

The communication network may comprise a telecommunications network and may include routing means adapted to selectively direct the transmitted signals along either of the at least two paths depending on the condition of the network.

The network may comprise a wireless telecommunications network, and the transmitted and received signals may comprise encoded digital signals.

Each of the protection devices may include an antenna and signal receiver for receiving a GPS signal and means for extracting a timing signal from the received GPS signal.

### BRIEF DESCRIPTION OF THE DRAWINGS

There will now be described, by way of example only, embodiments of the present invention with reference to the accompanying drawings, in which:

FIG. 1 is a schematic illustration of a section of power line and an associated protection scheme;

FIG. 2 is a schematic illustration of the components included within each protection device in the scheme of FIG. 1, the devices being arranged in accordance with the present invention;

FIG. 3 is a time-line diagram illustrating for a prior art Numerical Current Differential protection scheme the times at which current measurements are made at each end of a power line section and the time of propagation of signals between the two ends of the section; and

FIG. 4 is a further time-line diagram illustrating for the present invention the times at which current measurements are made at each end of the power line section and the time of propagation of signals between the two ends of the section.

### DETAILED DESCRIPTION OF PREFERRED EMBODIMENTS

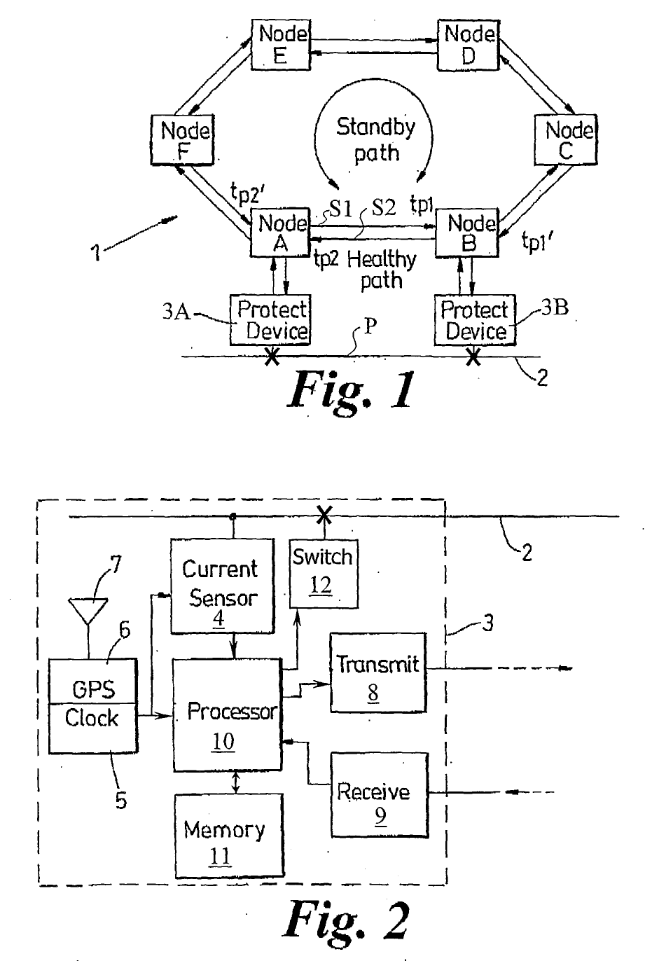

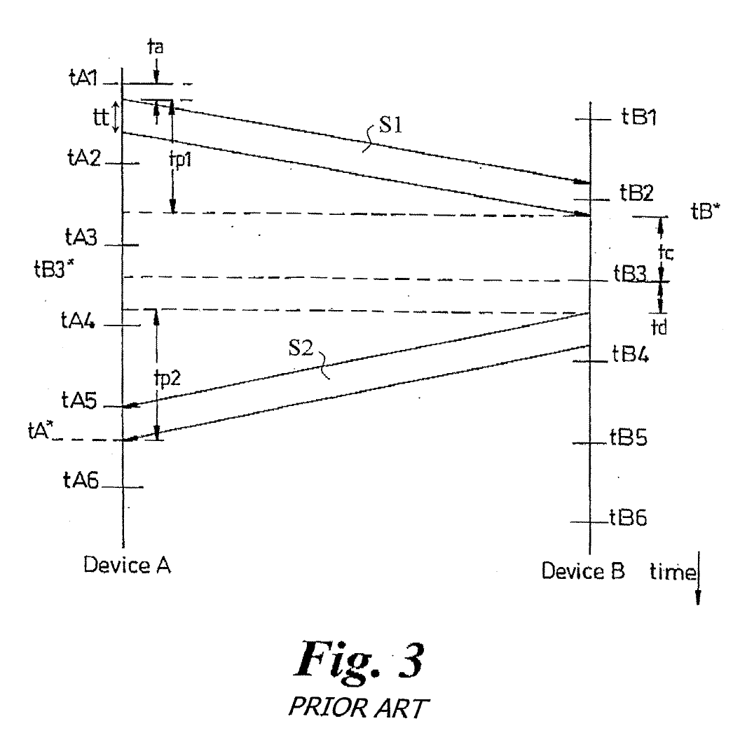

A simple communications network employing a Synchronous Digital Hierarchy is illustrated in FIG. 1 of the accompanying drawings. The network comprises a communications ring 1 having six nodes A to F. Two of these nodes A and B respectively are shown as connecting the ring to two protection devices 3A and 3B which are in turn connected to respective circuit breakers indicated by the symbol X. These circuit breakers are positioned at each end of a section P of a power line 2.

The provision of the ring topology allows the system to self-heal in the event of a failure at any one point in the ring as there exist two paths for transmitting and receiving signals between the two protection devices. As shown, a signal may propagate along the healthy or worker path connecting two adjacent devices, or else around a standby path extending around the whole loop. Thus, the propagation times tp1 and tp2 of respective outward and return signals S1, S2 transmitted between devices 3A and 3B on the healthy path will be the same, unless either the outward or the return component of the path is interrupted.

The components included in each protection device 3A, 3B in accordance with the present invention are illustrated in FIG. 2 of the accompanying drawings. Each device 3 operates digitally and comprises a current sensing input module 4 which digitises analogue current sample measurements received from the power line 2. The input module 4 is driven by a clock 5 and captures current samples at fixed intervals depending upon the frequency of the clock. Each current sample represents the magnitude and phase of the current in the power line 2. The digitised current signals are input to a microprocessor module 10, which is also driven by the clock 5. Microprocessor module 10 processes the current signals and the time signals in accordance with the present invention, which is implemented by a program held in ROM associated with the microprocessor. An output of the processor 10 also controls switch 12. When processor 10 receives signals from the current sensor 4 which indicate a fault on the power line 2, processor 10 activates switch 12 to trip the circuit breaker indicated by X.

The device 3 also includes a GPS receiver 6 fed by an antenna 7. Receiver 6 extracts a timing signal included in signals issued by the constellation of orbiting GPS satellites. The GPS signal is used to synchronise the clock 5 of each protection device 3 to a common time frame and hence synchronise the capture of current samples at widely spaced locations on the power line. For example, considering two devices called device A and device B (equivalent to 3A and 3B in FIG. 1), current samples will be obtained at times tAn and tBn, where n is the time cycle number of the clock or some other value representative of time. Hence, for device A, a first measurement will be captured at time tA1, and this will be synchronised with time tB1, which indicates when the first measurement for device B is taken.

Each protection device 3 also includes a transmitter 8, a receiver 9 and a read/write memory 11. Once every clock cycle the transmitter 8 receives a signal from processor 10 containing data relating to the measured current vector on power line 2 and the sampling time and transmits it across the communication network to the other devices on the network. Similarly, the receiver 9 receives signals sent by the other devices on the communication network and inputs them to the processor 10. Memory 11 holds data relating to current vectors and sampling times processed by the processor 10 for at least one to several preceding clock cycles. If the GPS signal input ceases, it can be arranged, for example, that a flag bit appears or ceases to appear in the signal from the clock 5, causing the processor 10 to operate in a different mode, in which it compares the timing data held in memory 11 with the latest data arriving over the network, thereby to perform a method in accordance with the present invention.

Note that although all the components of protection device 3 are shown within a single housing (indicated by a broken line) at least the antenna 7 and switch 12 may be located outside it.

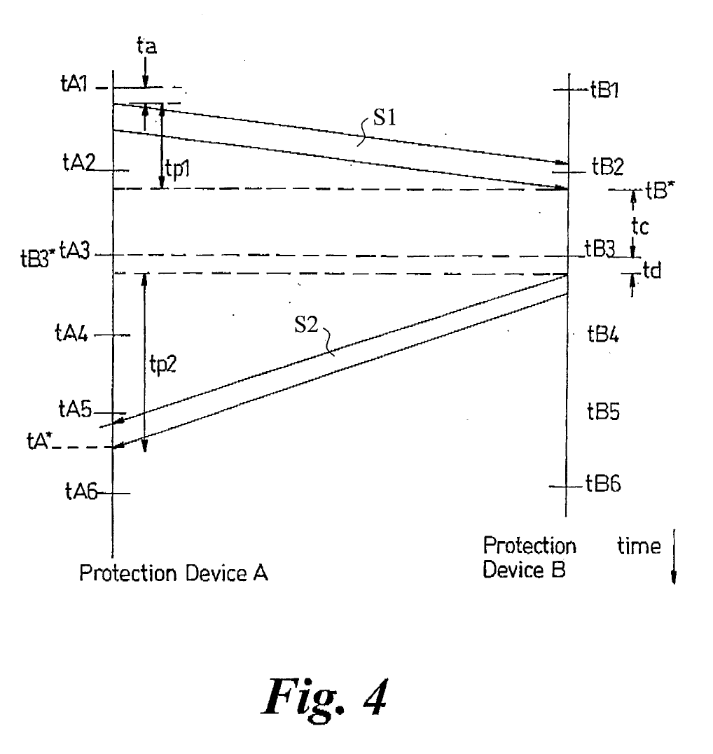

The sequence of capture of current samples and of communication between two of the devices A and B is illustrated in the timeline of FIG. 4 of the accompanying drawings.

As illustrated in FIG. 4, protection device A initially captures what we shall call a first current sample at time tA1. The captured signal is processed in processor 10 to form an outward transmission signal S1 which includes a first time tag tA1 and preferably also includes the value of the first current sample. This signal is sent across the network to device B. The time of propagation of the outward signal S1 will vary depending upon the path taken but can be denoted as tp1.

A short first delay ta due to signal processing will also exist between capturing the sample and transmitting the signal. This delay will be of fixed (known) value and will typically be dependent upon the hardware employed in the protection device 3. Optionally, data representing the delay time ta may be included in the outward signal S1 but in some cases it may be considered insignificant.

Upon receiving the whole of the outward signal S1 at time tB*, and after a second delay tc, device B captures a second current sample at the next available clock cycle. In the example shown, this is at time tB3, i.e., two cycles after tA1. (In practice, the number of clock cycles between capturing a sample at A and the next available clock cycle at B after reception of the signal from A will depend upon the propagation time tp1 and the clock speed and may in some cases exceed two cycles delay.) Note that because the clocks are synchronised, time tB3 is known to be equal to time tA3.

After capturing the second current sample, there will be a short third delay td similar in nature to the first delay ta and then the second device B will transmit a return signal S2 to the first device A. This return signal includes the information in the outward signal S1 and at least also data relating to the second current measurement and the second time tag tB3. The return signal S2 is received by device A after a signal propagation time tp2 and the time tA* of receiving the whole signal is recorded. Since the second delay tc is likely to be significant, the return signal preferably includes data relating to it. Where the delay is significant the return signal S2 may also include information defining the third delay time td between capturing the second current measurement and transmitting the return signal S2.

Using the information contained within the return signal and knowing its time of receipt tA*, Device A derives the total signal propagation time tp1+tp2 according to:

Total propagation time=tA*−tA1

if delays ta, tc and td can be ignored, or

Total propagation time=tA*−tA1−ta−tc−td,

if these delays are significant and are therefore included in the return signal S2. The value of the total propagation time is stored as a reference in an area of electronic memory provided at device A.

To derive a value for the outward propagation time tp1, the processor can compare the second time tag tB3 with the time of transmission of the first signal. Thus,

tp1=tB3−tA1−ta−tc,

While the GPS signal is being received to control the clock in each device, the timelines for devices A and B are synchronised with each other, and therefore tA3 could be substituted for tB3 in the above expression without changing its value.

Additionally or alternatively, to derive a value for the return propagation time tp2, the processor can compare the receive time tA* of the whole return signal S2 with the second time tag tB3 (or its equivalent tA3 on the device A timeline). Thus,

tp2tA*−tB3−td

It is notable that the outward and return propagation times can only be calculated if the GPS signal is present, thereby allowing the exact time of capture of the second signal to be determined. In practice, the transmission and receipt of pairs of outward and return signals is repeated on each clock cycle n and at least two sets of current measurements are stored in memory at device A. The current samples which correspond to identical points in time, such as tB5=tA5, can then be compared to detect faults in the power line. In some circumstances the GPS signal may be lost. In this case it is not possible to keep the clocks of the protection devices in syrichronisation and so tAn may no longer be the same as tBn. In this mode of operation, device A continues to transmit the outward signal S1 and receive the return signal S2. The total elapsed time tA*−tA1 between capturing the first current measurement at device A and receiving an associated return signal from device B is compared with a stored reference value for the total propagation time tp1+tp2 (+delays ta, tc and td, if these are significant). If this is the same, it is presumed that the propagation path has not changed and therefore that the outward and return propagation times have also not changed; therefore, the exact capture time of the second current measurement can be determined either by subtracting the return propagation time tp2 stored during the first mode of operation (and delay time td, if present) from the receive time tA* for the return signal S2, or adding a value for outward propagation time tp1 stored during the first mode of operation (and delay time tc, if present) to the transmit time of the outward signal S1. However, if tA*−tA1 varies by more than a predetermined amount (e.g., one clock pulse) from the stored reference value, it is assumed that the propagation path has changed and in this case the protection device is programmed to issue an error signal. It can be arranged that the error signal triggers a message on a monitor to indicate that it is no longer safe to rely on the protection device to protect the section of power line to which it is attached.

1. A method of determining the time of capture of current measurements obtained by first and second protection devices (3A, 3B) at first and second spaced apart points along a power line (2), a first current measurement being captured at the first device (3A), which sends an outward signal (S1) including the first current measurement to the second device (3B), a second current measurement being captured at the second device, which sends a return signal (S2) including both current measurements to the first device, characterised in that the timing of both measurements is synchronised using a GPS signal and the total propagation time (tp1+tp2) of the outward and return signals is calculated and stored in a memory (11), wherein if the GPS signal is lost, the stored total propagation time is used to calculate the actual time of measurement (tB3) of the second signal relative to the first signal.

2. A method according to claim 1, in which the protection devices are part of a communication network of the synchronous digital hierarchy type, and if the GPS signal is lost, the stored total propagation time is compared with total propagation times acquired during loss of the GPS signal to determine if the signal transmission path around the network has changed.

3. A method according to claim 1, in which if the transmission path changes, the method includes issuing a fault signal to alert observers that the operation of the protection devices is no longer reliable.

4. A method of determining the time of capture of current measurements obtained by first and second protection devices (3A, 3B) provided respectively at first and second spaced points along a power line, the method comprising:
(a) obtaining a first measurement of the current at the first point,
(b) generating a first time tag indicative of a time (tA 1) at which the first measurement was made;
(c) transmitting an outward signal (S1) from the first protection device to the second protection device, the signal including at least the first time tag;
(d) obtaining a second measurement of the current at the second point,
(e) generating a second time tag indicative of a time (tB3) at which the second measurement was made; and
(f) transmitting a return signal (S2) from the second protection device to the first protection device, the return signal including at least the first and second time tags and data representing the second measured current;
characterised in that:
(A) during a first mode of operation the method includes the steps of;
(i) generating each of the time tags to represent a time of measurement relative to a common time clock (GPS) derived from a remote clock signal,
(ii) deriving from the information contained in the return signal (S2)
a total propagation time (tp1+tp2) for the outward signal S1 and the return signal and
the outward signal propagation time (tp1) and/or the return signal propagation time (tp2), and
(iii) storing the total propagation time and the outward propagation time and/or the return propagation time in a memory (11);
(B) during a subsequent second mode of operation in which the remote clock signal (GPS) is unavailable, the method includes the further steps of;
(i) comparing a new total propagation time (tp1+tp2) for an outward signal (S1) and a return signal (52) with a value for total propagation time stored during the first mode of operation, and if the new and stored total propagation times are substantially identical,
(ii) deriving the time (tB3) at which the second measurement was made by a calculation including
subtracting a value for return propagation time (tp2) stored during the first mode of operation from the receive time (tA*) of the return signal, or
adding a value for outward propagation time (tp1) stored during the first mode of operation to the transmit time (tB3) of the outward signal.

5. The method of claim 4 in which the remote clock signal is obtained by providing a Global Positioning Satellite receiver (6) for each of the first and the second protection devices and deriving the clock signal from the received GPS signal.

6. A method according to claim 4 or claim 5 which further comprises during the second mode of operation the step of issuing an error signal if the most recently calculated total propagation time (tp1+tp2) and the value for total propagation time stored during the first mode of operation differ by an amount exceeding a predetermined value.

7. The method of any preceding claim in which the outward signal (S1) includes first delay data representative of a time delay (ta) between obtaining the first current measurement and transmitting the outward signal and the return signal (S2) also includes the first delay data.

8. The method of claim 7, in which the return signal (S2) further includes second delay data representative of a time delay (tc) between receiving the outward signal and obtaining the second current measurement.

9. The method of claim 8, in which the return signal further includes third delay data representative of a time delay (td) between obtaining the second current measurement and transmitting the return signal.

10. The method of any one of claims 1 to 6, in which the return signal (S2) includes data representative of a time delay (tc) between receiving the outward signal (S1) and obtaining the second current measurement, and in which the outward propagation time (tp1) is calculated by subtracting the time delay (tc) from the difference between the transmit time (tA1) of the outward signal and the second time tag value (tB3).

11. The method of claim 10 which further includes the step of calculating the total propagation time (tp1+tp2) by subtracting the delay (tc) between receiving the outward signal and obtaining the second current measurement from the difference between the time (tA1) of the first current measurement and the time (tA*) of receiving the return signal.

12. A protection system for an electrical power network comprising a plurality of protection devices (3A, 3B) arranged in a synchronous digital hierarchy and having synchronising means (5, 6, 7) using a common timing signal obtained from global positioning satellites, the protection devices being adapted to communicate with each other by means of the Numerical Current Differential (so-called “Ping-Pong”) technique.

13. A protection system for a section of power line (2) including at least first and second protection devices (3A, 3B) located respectively at spaced locations along the section of power line and a communication network (1) providing at least two different communication paths between the protection devices, each protection device including a clock signal generator (5) synchronised to a time signal derived from a remote clock source which is common to all the protection devices, a current sensor (4), a data processor (10), a transmitter (8) for transmitting signals across the communication network, a receiver (9) for receiving signals from the network and switch means (12) for operating an associated circuit breaker (X) in the power line, the processor of each protection device being configured to trigger the switch means to isolate the section of line in the event that the current measurements indicate the presence of a fault on the line, characterised in that the protection devices are configured to perform the method of any one of claims 1 to 11.

14. The system of claim 13 in which the communication network comprises a telecommunications network and includes routing means adapted to selectively direct the transmitted signals along either of the at least two paths depending on the condition of the network.

15. The system of claim 13 or claim 14 in which each protection device includes an antenna and signal receiver for receiving a GPS signal and means for deriving a timing signal from the received GPS signal.
